(19) United States
(12) Patent Application Publication
(10) Pub. No.: US 2019/0230930 A1
(43) Pub. Date: Aug. 1, 2019

(54) Insect Repellent and Insecticide

(71) Applicant: Aaron Baba, GRA Lokoja (NG)

(72) Inventor: Aaron Baba, GRA Lokoja (NG)

(21) Appl. No.: 15/883,284

(22) Filed: Jan. 30, 2018

(51) Int. Cl. A01N 53/00; A01N 43/40; A01N 25/04; A01N 65/44

(52) U.S. Cl. CPC A01N 53/00; A01N 43/40; A01N 2300/00; A01N 65/44; A01N 25/04

(57) ABSTRACT

In accordance with an example embodiments of the present disclosure, the invention provides an insecticide composition comprising a permethrin component, a tetramethrin component, a pyriproxyfen component, a sodium lauryl sulfate component, an isopropanol component and de-ionized water. In accordance with an additional example embodiments of the present disclosure, the invention provides an insect repellent insecticide composition comprising a permethrin component, a tetramethrin component, pyriproxyfen component, a citronella component, a lemongrass oil component, a sodium lauryl sulfate component an isopropanol component and de-ionized water.

### TECHNICAL FIELD

The present invention relates to a topical composition. In particular, it relates to an insect repellent insecticide composition.

### BACKGROUND

Pests that threaten food crops are commonly mitigated with readily available chemical pesticides. Common chemicals include pyrethroids such as permethrin, allethrins, phenothrin, resmethrin, cypermethrin and tetramethrin. The insects that these chemicals are intended to control, typically become resistant to these chemicals over time and thereby necessitate the use of increasing concentrations, the development of new pesticides or a combination of several chemicals for effective control.

The combination of some active ingredients can result in a synergistic effect. A synergistic effect is an effect arising between two or more agents, entities, factors, or substances that produces an effect greater than the sum of their individual effects.

Permethrin belongs to the family of synthetic chemicals called pyrethroids and functions as a neurotoxin, affecting neuron membranes by prolonging sodium channel activation. It elicits strong contact irritant response in vectors and is an excito-repellent. The term “excito-repellency” is used to describe behavior that is triggered by the combination of either irritancy or repellency. Irritancy results from direct tarsal contact with an insecticide that can cause a pest to leave treated surfaces before acquiring a lethal dose, therefore repeated contact is required before mortality occurs. On the other hand, repellency refers to the stimulation by a chemical that orients pest movement away from the treated surfaces without making tarsal contact. Permethrin serves both as an irritant and repellent.

Tetramethrin is a broad-spectrum, first-generation synthetic pyrethroid insecticide. It is a rapid knockdown agent against flying and crawling insects, and acts on axons in the peripheral and central nervous system by interacting with sodium channels in pests. It is a nerve cell membrane sodium channel modulator, which interferes with entrance of sodium ions into the channel, leading to hyperactivity of the nervous system which can result in paralysis and/or death of the pest.

Pyriproxyfen is an insect growth regulator. It mimics natural insect hormones that stop young insects from maturing into adults and affects an insect if it is touched or eaten. Pyriproxyfen is rarely toxic to adult insects but instead disturbs egg-laying and egg-hatching and keeps young insects from growing into adult forms, thereby preventing target insects from multiplying.

Isopropyl alcohol, also called isopropanol or dimethyl carbinol, is a compound with the chemical formula C₃H₈O or C₃H₇OH or CH₃CHOHCH₃

### SUMMARY

The present invention is directed to a formulation for the control of insects. Active ingredients include permethrin, tetramethrin and pyriproxyfen and a solvent chosen from the group consisting of isopropanol, methanol water; and emulsifying agents sodium lauryl sulfate, triton-100.

The formulation includes an insecticide, repellent and growth regulator. A synergistic effect occurs in the combination of permethrin, tetramethrin and pyriproxyfen. In the presence of multiple active components, insects require a relatively longer time to adapt to a combination than to a single element thus mitigating pesticide resistance. The formulation is effective against eggs, larvae and adult insects. The formulation kills adult insects, larva and deactivates eggs, thereby disrupting the life cycle.

One embodiment includes a composition of permethrin, tetramethrin, pyriproxyfen, sodium lauryl sulfate and a solvent. One skilled in the art understands that solvents may be combined from the following group: isopropanol, methanol, and water.

The amount of permethrin component can vary from about 5% by weight to about 15% by weight, preferably about 10% by weight of the total weight of the insecticide composition.

The amount of tetramethrin component can vary from about 1% by weight to about 8% by weight, preferably about 4% by weight of the total weight of the insecticide composition.

The amount of pyriproxyfen component can vary from about 0% by weight to about 4% by weight, preferably about 2% by weight of the total weight of the insecticide composition.

Some embodiments consist of a 200× dilution of the formulation in water. A dermatological assessment of a 16× dilution exhibited no adverse effect on the skin. A 200× dilution of the product in water has been found to be effective against mosquitoes, cockroaches, spiders, termites, cashew stem girdlers, tuta absoluta, and a wide range of other pests. This product formulation is effective against common pests that are present in homes and on farms, namely alfalfa loopers, Ants, aphids, armyworms, bagworms, bedbugs, beetles, borers, brown dog, ticks, budworms, cabbageworms, chinch bugs, cicadas, citrus black flies, cluster flies, codling moths, corn earworms, crickets, cutworms, carwigs, elm spanworms, fall cankerworms, fire ants, fleas, green fruitworms, gnats, grasshoppers, houseflies, inchworms, Japanese beetles, Leafhoppers, Leafminers, Leafrollers, lice, Lone Star ticks, Lygus bugs, mealybugs, millipedes, mole crickets, mosquitoes, moths, navel orangeworms, scales, scorpion, sod webworms, sowbugs (pillbugs), spider mites, spring cankerworms, tent caterpillars, termites, thrips, ticks, tobacco budworms, weevils, whiteflies

Another embodiment is an insecticide, insect repellent and air freshener, adapted for household use. The modified formulation in one embodiment includes a composition of permethrin, tetramethrin, pyriproxyfen, citronella oil, lemongrass oil, sodium lauryl sulfate and a solvent. One skilled in the art understands that solvents may be combined from the following group: isopropanol, methanol, and water.

The amount of permethrin component can vary from about 0.5% by weight to about 2% by weight, preferably about 1% by weight of the total weight of the insecticide composition.

The amount of tetramethrin component can vary from about 0.5% by weight to about 2% by weight, preferably about 1% by weight of the total weight of the insecticide composition.

The amount of pyriproxyfen component can vary from about 0.2% by weight to about 2% by weight, preferably about 0.5% by weight of the total weight of the insecticide composition.

The amount of citronella oil component can vary from about 0.2% by weight to about 2% by weight, preferably about 0.5% by weight of the total weight of the insecticide composition.

The amount of lemongrass oil component can vary from about 0.2% by weight to about 2% by weight, preferably about 0.5% by weight of the total weight of the insecticide composition.

The amount of sodium lauryl sulfate component can vary from about 0.2% by weight to about 2% by weight, preferably about 0.5% by weight of the total weight of the insecticide composition.

The present embodiment also includes an emollient ester component, preferably isopropyl alcohol. The amount of ester emollient component can vary from about 80% by weight to 90% by weight, preferably from about 84% by weight to 86% by weight of the total weight of the insect repellent insecticide composition.

The present embodiment also includes de-ionized water.

Other objects and features will become apparent from the following detailed description considered in conjunction with the accompanying drawings. It is to be understood, however, that the drawings are designed as an illustration and not as a definition of the limits of the invention.

### DETAILED DESCRIPTION

While the specification concludes with claims particularly pointing out and distinctly claiming the invention, it is believed that the present invention will be better understood from the following description.

All percentages and ratios used hereinafter are by weight of total composition, unless otherwise indicated. All measurements referred to herein are made at 25° C. unless otherwise specified.

All percentages, ratios, and levels of ingredients referred to herein are based on the actual amount of the ingredient, and do not include solvents, fillers, or other materials with which the ingredient may be combined as a commercially available product, unless otherwise indicated.

Preferably, a composition of the embodiment of the present disclosure includes about 10% by weight of permethrin, up to 4% by weight of tetramethrin, up to about 2% by weight of pyriproxyfen, up to about 0.5% by weight of sodium lauryl sulfate and up to about 85% by weight of isopropanol, methanol and de-ionized water. An example of a preferred composition for a 100 ml product volume, of the example embodiment of the present disclosure is as follows:

### Example 1

| | | |
|---|---|---|
| Permethrin | 10% | (10 ml) |
| Tetramethrin | 4% | (4 ml) |
| Pyriproxyfen | 2% | (2 ml) |
| Sodium Lauryl Sulfate | 0.5% | (0.5 ml) |
| Isopropanol, methanol and De-ionized water | 85% | (85 ml) |

Preferably, a composition of the embodiment of the present disclosure includes about about 1% by weight of permethrin, up to about 1% by weight of tetramethrin and up to about 0.5% by weight of pyriproxyfen and up to about 0.5% citronella oil and about 0.5% lemongrass oil and about 0.5% sodium lauryl sulfate and about 86% solvent consisting of isopropanol methanol and de-ionized water. An example of a preferred composition for a 100 ml product volume, of the example embodiment of the present disclosure is as follows:

### Example 2

| | | |
|---|---|---|
| Permethrin | 1% | (1 ml) |
| Tetramethrin | 1% | (1 ml) |
| Pyriproxyfen | 0.5 | (0.5 ml) |
| Lemongrass oil | 0.5% | (0.5 ml) |
| Citronella oil | 0.5% | (0.5 ml) |
| Sodium lauryl sulfate | 0.5% | (0.5 ml) |
| Isopropanol, methanol and de-ionized water | 86% | (40 ml) |

While the present invention is described above in connection with preferred or examples and these examples are not intended to be exhaustive or limiting of the invention. Rather, the invention is intended to cover all alternatives, modifications and equivalents included within its scope, as defined by the appended claims.

1. A composition of matter comprising an insecticide compound comprising:
permethrin,
tetramethrin
pyriproxyfen
sodium lauryl sulfate
and a solvent.

2. The insect repellent composition of claim 1, wherein the permethrin is present from about 9% by weight to 11% by weight.

3. The insect repellent composition of claim 1, wherein the tetramethrin is present from about 3% by weight to 5% by weight.

4. The insect repellent composition of claim 1, wherein the pyriproxyfen is present from about 1% by weight to 3% by weight.

5. The insect repellent composition of claim 1, wherein the sodium lauryl sulfate is present from about 1% by weight to 3% by weight.

6. The insect repellent composition of claim 1, wherein the isopropanol is present from about 35% by weight to 45% by weight.

7. The insect repellent composition of claim 1, wherein the de-ionized water is present from about 25% by weight to 35% by weight.

8. A composition for repelling and deterring landing and feeding and subsequent growth and development by blood feeding arthropods on an animal comprising an effective amount of one or more compounds selected from the group consisting of permethrin, tetramethrin, pyriproxyfen, sodium lauryl sulfate, isopropanol and a suitable carrier, wherein the composition is for application to vegetation and crops.

9. A method of repelling and deterring landing and feeding, and subsequent growth and development by blood feeding arthropods on an animal, comprising applying an effective amount of one or more compounds selected from the group consisting of, permethrin, tetramethrin, pyriproxyfen, sodium lauryl sulfate, isopropanol and a suitable carrier wherein the one or more compounds is for application to vegetation and crops.

10. A composition of matter comprising a mosquito repellent and insecticide compound suitable for topical application comprising:
permethrin,
tetramethrin,
pyriproxyfen.
lemongrass oil,
citronella oil,
sodium lauryl sulfate, and
a solvent

11. The insect repellent and insecticide composition of claim 10, wherein the permethrin is present from about 0.5% by weight to 2% by weight.

12. The insect repellent and insecticide composition of claim 10, wherein the tetramethrin is present from about 0.5% by weight to 2% by weight.

13. The insect repellent and insecticide composition of claim 10, wherein the pyriproxyfen is present from about 0.1% by weight to 1% by weight.

14. The insect repellent and insecticide composition of claim 10, wherein the citronella oil is present from about 0.1% by weight to 1% by weight.

15. The insect repellent and insecticide composition of claim 10, wherein the lemongrass oil is present from about 0.1% by weight to 1% by weight.

16. The insect repellent and insecticide composition of claim 10, wherein the sodium lauryl sulfate is present from about 0.1% by weight to 1% by weight.

17. The insect repellent and insecticide composition of claim 10, wherein the solvent is present from about 80% by weight to 90% by weight

18. A composition for repelling and deterring landing and feeding and subsequent growth and development by blood feeding arthropods on an animal comprising an effective amount of one or more compounds selected from the group consisting of permethrin, tetramethrin, pyriproxyfen, lemongrass oil, citronella oil, sodium lauryl sulfate, isopropanol and a suitable carrier, wherein the composition is for application to the skin, clothing or environment of the animal, and wherein the arthropods are blood feeding insects in the Order Diptera.

19. A method of repelling and deterring landing and feeding, and subsequent growth and development by blood feeding arthropods on an animal, comprising applying an effective amount of one or more compounds selected from the group consisting of, permethrin, tetramethrin, pyriproxyfen, lemongrass oil, citronella oil, sodium lauryl sulfate, isopropanol and water wherein the one or more compounds is for application to the skin, clothing or environment of the animal, and wherein the arthropods are blood feeding insects in the Order Diptera.
